(19) United States
(12) Patent Application Publication
(10) Pub. No.: US 2015/0103978 A1
(43) Pub. Date: Apr. 16, 2015

(54) Cooled Rotary Anode for an X-Ray Tube

(71) Applicant: Quantum Technologie (Deutschland) GmbH, Puchheim (DE)

(72) Inventor: Ki CHAN, Wanchai (HK)

(21) Appl. No.: 14/551,690

(22) Filed: Nov. 24, 2014

Related U.S. Application Data
(63) Continuation of application No. PCT/EP2012/059767, filed on May 24, 2012.

(51) Int. Cl. H01J 35/10; H01J 31/04

(52) U.S. Cl. CPC H01J 35/105; H01J 35/101; H01J 31/04
USPC 378/129; 378/144

(57) ABSTRACT

An anode 30 for an X-ray tube 10 comprising at least a stem 29 for rotary supporting the anode 30 and a disc 34, being coaxially attached to the stem 29 and having a peripheral target area 32 as target for an electron beam 27 on its frontal side, can be efficiently cooled if the anode 30 has at least one cavity extending into the disc 34 and in particular, if the cavity has a coating 50 of at least one inorganic salt.

### PRIORITY CLAIM

This application is a continuation of pending International Application No. PCT/EP2012/059767 filed on 24 May 2012, which designates the United States and is incorporated by reference in its entirety.

### BACKGROUND OF THE INVENTION

1. Field of the Invention

The invention relates to a cooled anode for an X-ray tube and to an X-ray tube.

2. Description of Relevant Art

X-ray tubes are of significant importance in medical imaging, in particular as X-ray sources for CT-scanners. Of course X-ray tubes are as well important in other technological fields as there are for example the determination of crystal structures (see e.g. Ashcroft Mermin Solid State Physics, Saunders College Publishing, Chapt. 6) or the quick and reliable radiography which has become common use by customs authorities, to name only a few. These applications require a high radiated power for obtaining detailed information about the objects being subjected to an X-ray based analysis.

Briefly speaking X-rays are produced by an abrupt slowing down of previously accelerated electrons. To this end an X-ray tube comprises a cathode, often in form of a coiled filament. The filament is heated by a applying a current to the filament to induce thermal emission of the electrons. The electrons are drawn of by an anode. The voltage between the anode and the cathode is typically of the order of a several kV, e.g. 25 to 150 kV. The electrons are thus accelerated towards the anode up to several keV, until they are slowed down by inelastic scattering with the anode's atoms. Due to energy conservation a part of the electrons' kinetic energy is emitted as phonons, i.e. X-rays, having a continuous energy spectrum. The emission of the x-rays is as well referred to as Bremsstrahlung. Often, peaks are observed in radiation spectra of x-ray tubes. These peaks are due to a recombination of excited electrons of the atoms. The high kinetic energy of the electrons impinging the anode is unfortunately not only converted into short wavelength radiation but as well into heat. Only a few percent of the electrical power provided to an X-ray tube is typically converted into X-rays, the remaining power is converted into heat. Efficient cooling of the X-ray tube, in particular of the anode is crucial for obtaining high X-ray intensities.

U.S. Pat. No. 6,807,382 B2 discloses an X-ray tube. The X-ray tube has as usual an evacuated compartment. In the compartment are a cathode for thermal emission of electrodes and a tungsten alloy anode as target for the electrons. The anode is disc shaped and has a circular peripheral area onto which the electrons are focused. The disc is mounted on a rotor shaft of a motor, thus in operation the focal point of the electron beam forms a circular focal track on the peripheral area. Attached to the rear side of the anode disc is a graphite back plate as heat sink. Heat is transferred from the anode to its back plate by heat pipes. The heat pipes are briefly speaking evacuated cylindrical metal shells, being partially filled a working fluid like Sodium, Lithium, Zink or the like, i.e. fluids under operating conditions of the anode. In each metal shell is a capillary wick, being surrounded by a tube. The wick serves to transport the fluid to an evaporation end of the shell, which is in the proximity of the focal track. Thus, heat produced by the electrons impinging the focal track evaporates the liquid. The evaporated liquid (now in a gas state) condenses at the other end of the shell and thus transports heat from a region just behind the focal track towards the back plate.

DE 10 2005 049 270 A1 discloses an X-ray tube with a rotary anode. The anode is cooled by a flow of water through the anode. The cooling water is supplied via an axial bore and warmed by contacting the rear side of the anode. The warmed water is removed via a conduit. The conduit coaxially surrounds the bore.

EP 1 675 151 suggests to apply an anti-rust coating to a water cooled rotary anode. Beyond other anti-rust coatings, a coating formed of an inorganic salt is suggested. However, a coating of inorganic salts is soluble to water and will be washed away.

The above summary of the related prior art is not intended to be applicant's admitted prior art, but to be perceived as a starting point of the invention.

### SUMMARY OF THE INVENTION

The invention is based on the observation, that the heat transfer mechanism for cooling the anode is complicated and expensive. Water cooling of a rotary anode requires water tight rotary joints for providing the rotary anode with water and for removing the warmed water from the anode.

The problem to be solved by the invention is to provide a simple and thus less expensive heat transfer mechanism for cooling the anode of an X-ray tube.

The problem is solved by providing an anode for an X-ray tube. The anode may have a stem for rotary supporting the anode. A disc may be coaxially attached to the stem. The stem and the disc are preferably integrally formed. Preferably, the disc has a peripheral target area on its frontal side, for example an inlet made of tungsten. The anode has at least one cavity, extending from the stem into the disc. Accordingly the cavity may be formed by inner walls of the stem and/or the disc. At least part of the inner surface of the stem and/or the disc may be coated by at least one inorganic salt. Alternatively one may say that at least a part of the cavity is coated by at least one inorganic salt. More preferably the coating is a composition of inorganic salts as explained below in more detail. This inorganic salt or composition, respectively form a coating with an excellent thermal conductivity on the inner surfaces of the disc and the stem, respectively. This enables an efficient and simple heat transfer from the region of the target surface, to some cooling device. Water cooling of the anode may be omitted. Accordingly the cavity may be evacuated. Here, evacuated means that the cavity is essentially empty, it may still comprise some gas molecules, but at a lower pressure than ambient pressure.

Preferably, the cavity extends from the center of the disc at least to an area being opposite of the target area. The heat is produced in the material just behind the target area by electrons entering the solid and interacting with electrons of the solid's atoms. If the coated cavity extends to an area being opposite to the target area, the heat can be conducted from its place of origin to some cooling device, e.g. a heat sink.

The cavity may preferably be evacuated and may have an, e.g., coaxially aligned cylindrical trough hole. This through hole enables to apply the coating by filling a solution of the inorganic salt(s) (or the composition) to the cavity and to subsequently remove the solvent to thereby apply the coating. This procedure may be repeated multiple times. The solvent may be water, which can easily be removed, e.g., by heating the anode and/or reduction of the pressure in the cavity.

After coating, the cavity may preferably be evacuated, e.g., via the through hole, which may be closed afterwards, for example by a valve.

The disc may comprise at least a front half shell and a rear half shell. The two shells may be attached to each other thereby forming a recess in between of the shells. The recess may be a part of the cavity. This permits on the one hand to efficiently manufacture the disc with the cavity and at the same time to choose different materials for the front half shell and the rear half shell, to better adapt the two half shells to the operating conditions of the anode.

In a preferred embodiment, at least the rear half shell comprises a Molybdenum alloy body as this enhances heat dissipation and durability of the anode.

The coating may preferably comprise inorganic oxides. A solution for coating the cavity may comprise a composition of the following constituents (variations of the composition of about 10% are tolerable):

| | |
|---|---|
| sodium peroxide | 2.705% |
| disodium oxide | 2.505% |
| Silicon | 1.6% |
| diboron trioxide | 0.505% |
| Titanium | 0.405% |
| copper oxide | 0.405% |
| cobalt oxide | 0.255% |
| beryllium oxide | 0.255% |
| water, distilled, conductivity or of similar purity | 89.256% |
| dirhodium trioxide | 1.6% |
| trimanganese tetraoxide | 0.255% |
| strontium carbonate | 0.255% |

This composition is only one possible composition. Examples for further compositions are for example described in U.S. Pat. Nos. 6,132,823, 6,911,231, 6,916,430, 6,811,720 and U.S. Publication No. 2005/0056807, which are incorporated by reference as if fully disclosed herein. The coating provided by applying the such compositions to the cavity acts as a thermally conductive material to provide at least an almost perfect homogenous distribution of the heat produced by the impinging electrons. The cavity may as well be evacuated as suggested in the above references. The thermally conductive material is an inorganic material that is a combination of oxides and one or more pure elemental species, particularly titanium and silicon.

The anode may of course be in included in an evacuated compartment of an X-ray tube. Such X-ray tube may comprise at least a cathode for emitting electrons. The cathode may be for example some tungsten filament, being configured for applying an electrical current. Additionally the X-ray tube may comprise means for focusing the electrons onto the target area of the anode and preferably means for rotary supporting the anode. At least the anode and the cathode are enclosed in the evacuated compartment. For example may the anode be rotary supported in the compartment. Alternatively, the compartment with the anode and the cathode may be rotated. The electron beam emitted by the cathode should preferably by focused to some point on the target area. At least the anode should be rotated with respect to the electron beam, such that the focal point follows a “focal track” on the target area.

The compartment may be enclosed by a housing, forming a cooling space between the compartment and the housing. A coolant may be circulated in the space. More preferably the coolant is circulated between a heat sink, or some other cooling device and the cooling space.

### BRIEF DESCRIPTION OF THE DRAWINGS

In the following, the invention will be described by way of example, without limitation of the general inventive concept, on examples of embodiment and with reference to the drawings.

FIG. 1 shows a cross section of a simplified X-ray tube.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF A PREFERRED EMBODIMENT

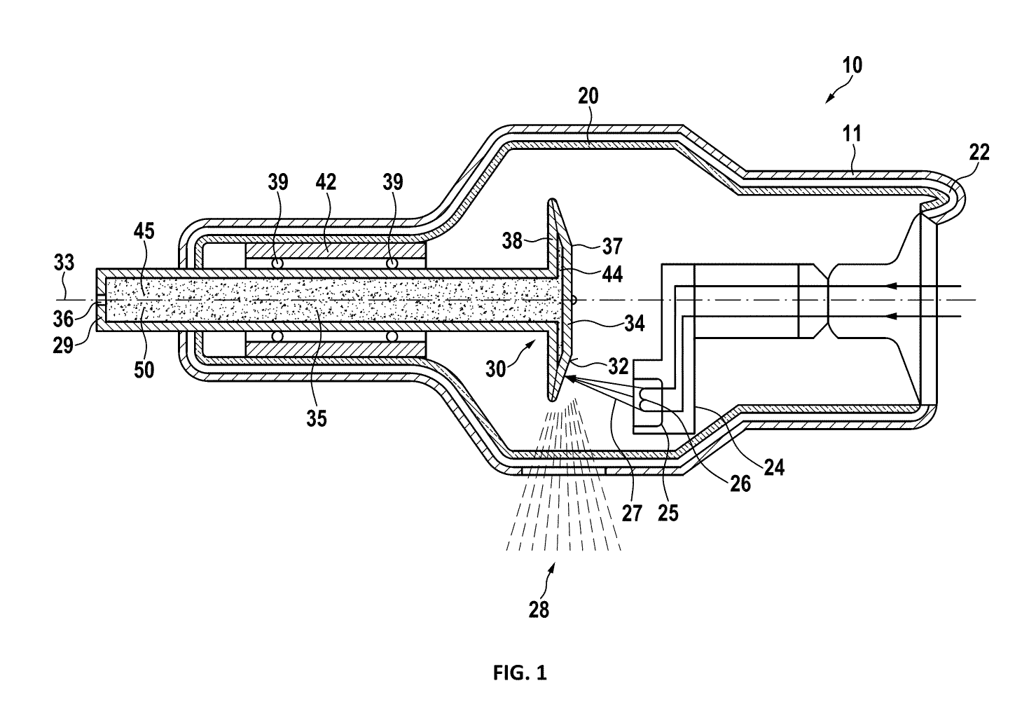

FIG. 1 shows a cross-section of a preferred embodiment of an X-ray tube.

The X-ray tube 10 in FIG. 1 has a compartment, being formed by compartment wall 20, e.g. of glass. The compartment 20 is enclosed in a housing 11, for example made of some metal. Between the compartment wall 20 and the housing 11 is a space 22, in which a coolant circulates. Preferably the coolant circulates between the space 22 and a heat exchanger (not shown).

The compartment 20 is evacuated and encloses a cathode assembly 24, having a filament cathode 26, being connected to a power supply. By applying electrical power to the cathode 26, the cathode 26 may be heated to obtain thermal emission of electrons.

The compartment 20 as well encloses part of an anode 30. The anode 30 has a T-shaped cross section. It comprises a stem 29 with a disc 34 attached to it. In the depicted example the stem 29 and the disc 34 are integrally formed, but may as well be separate parts. The disc 34 has a frontal side facing towards the cathode assembly 24. On the frontal facing side of the disc 34 is a peripheral target area 32 for electrons being emitted by the cathode 26 and subsequently accelerated by a voltage between cathode 26 an the anode 30.

The anode has a cavity 35 extending coaxially along axis 33. The cavity 35 includes a cylindrical hole 45 in stem 29, which extends into the disc 34. The stem has an opening 36 at its rear end.

The disc 34 has a front half shell and a rear half shell, forming a recess 44 in between. The recess is part of the cavity 34 and thus in fluid communication with the cylindrical hole 45 of the stem 29. The term “fluid communication” is not to be understood such that a fluid is in the cavity, but only to explain that one could apply a continuous coating 50 to the cavity. In addition a coolant, e.g. a gas could be circulated in cavity, e.g. via the opening 36 in the rear side of the anode.

The anode 30 is rotary supported to rotate around axis 33 by bearing means. The bearing means are supported by the compartment wall 20 and comprise a bearing housing 42 with outer races for bearing balls 39. Inner races for bearing balls 39 are provided on the outer surface of the stem 29. The anode 30 may be rotationally driven by a motor with an electrical stator (not shown).

Focusing means 25 focus the electrons 27 on a spot on the target area 32. Thus an electron beam 27 is focused on the target area 32. In operation the focal point of the electron beam 27 forms a focal track on the rotating stem 29, in particular on the target area 32 of the stem 29

At the inner surface of the anode 30 is a coating 50 comprising a composition of inorganic salts and elements, e.g., those listed above in Table 1. Preferably the inner surface is fully coated. The coating 50 has an excellent thermal conductivity and provides for an excellent dissipation of heat away from the target area 32.

In operation an electron beam 27 is emitted by the cathode 26 and focused on the target area 32. The anode 30 is rotated, thus the focused electron beam 27 impinges the anode 30 at a ring like focal track on the target area 32 as explained above. Part of the electrons are slowed down due to coulomb interaction with cores of atoms of the anode 30 and thus emits X-ray Bremsstrahlung. Most of the electrons however interact with electrons of the atoms and thus a large amount of their kinetic energy is converted into heat. This heat dissipates from the target area towards the cavity wall, and is thus transferred to the coating 50. Coating 50 participates and thereby enhances conduction of the heat away from the target area to the rear side of the anode, which is connected to some cooling device (not shown).

It will be appreciated to those skilled in the art having the benefit of this disclosure that this invention is believed to provide an enhanced X-ray tube. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 X-ray tube
11 housing
20 compartment/compartment wall
22 space, e.g. for coolant
24 cathode assembly
26 cathode
27 electron beam
28 X-rays
29 stem/shaft
30 anode
33 rotational axis of anode 30
34 disc
37 front half shell
38 rear half shell
35 cavity
36 opening of cavity
39 bearing balls
42 bearing housing
44 recess in disc (part of cavity 35)
45 cylindrical hole in stem (part of cavity 35)
50 coating

1. Anode for an X-ray tube, the anode comprising:
a stem for rotary supporting the anode, and
a disc coaxially attached to the stem and having a peripheral target area on a front side of the disk as a target for an electron beam,
wherein the anode has at least one evacuated cavity extending into the disc, the cavity having a coating of at least one inorganic salt.

2. The anode of claim 1 wherein
the cavity extends from the center of the disc at least to an area being opposite of the target area.

3. The anode of one claim 1 wherein
the cavity includes a coaxially aligned cylindrical hole of the stem.

4. The anode of claim 1 wherein
the disc comprises at least a front half shell and a rear half shell, being attached to each other thereby forming a recess, wherein the recess is part of the cavity.

5. The anode of claim 4, wherein
the rear half shell comprises an Molybdenum alloy body.

6. The anode of one claim 1, wherein
the coating comprise at least one of the members of the group consisting of Sodium Peroxide, Disodium Oxide, Silicon, Diboron Trioxide, Titanium, Copper Oxide, Cobalt Oxide, Beryllium Oxide, Dirhodium Trioxide, Trimanganese Tetraoxide and Strontium Carbonate.

7. X-ray tube, comprising at least a an evacuated compartment enclosing at least
a cathode for emitting electrons,
an anode with a target area, and
means for focusing the electrons onto the target area
wherein the anode has at least one evacuated cavity extending into the disc, the cavity having a coating of at least one inorganic salt.

8. X-ray tube of claim 7, wherein
the anode is supported in the compartment enabling a rotation of the anode.

9. X-ray tube of claim 7, wherein
the compartment is enclosed by a housing, forming a space between the compartment and the housing, and in that the X-ray tube comprises means for circulating a coolant in the space between the compartment and the housing.

10. X-ray tube of claim 8, wherein the anode is connected to a rotary drive.

11. X-ray tube, comprising at least a an evacuated compartment enclosing at least
a cathode for emitting electrons,
an anode with a target area, and
a ring configured to focus the electrons onto the target area
wherein the anode has at least one evacuated cavity extending into the disc, the cavity having a coating of at least one inorganic salt.

12. X-ray tube of claim 11, wherein
the anode is supported in the compartment enabling a rotation of the anode.

13. X-ray tube of claim 11, wherein
the compartment is enclosed by a housing, forming a space between the compartment and the housing, and in that the X-ray tube comprises means for circulating a coolant in the space between the compartment and the housing.

14. X-ray tube of claim 12, wherein the anode is connected to a rotary drive.
